(19) United States
(12) Patent Application Publication
(10) Pub. No.: US 2025/0369586 A1
(43) Pub. Date: Dec. 4, 2025

(54) METHOD FOR PROJECTING A DYNAMIC LIGHTING BEAM USING A LIGHTING SYSTEM OF A MOTOR VEHICLE

(71) Applicant: VALEO VISION, Bobigny (FR)

(72) Inventor: Constantin PRAT, Bobigny (FR)

(73) Assignee: VALEO VISION, Bobigny (FR)

(21) Appl. No.: 18/876,200

(22) PCT Filed: Jun. 30, 2023
(86) PCT No.: PCT/EP2023/068127

§ 371 Date: Dec. 18, 2024

(30) Foreign Application Priority Data
Jul. 1, 2022 (FR) FR2206711

(51) Int. Cl. F21S 41/663

(52) U.S. Cl. CPC F21S 41/663

(57) ABSTRACT

The invention relates to a method for projecting a dynamic lighting beam using a lighting system of a motor vehicle based on a compressed video. The method includes reading each image from the compressed video, decompressing the image for each of the read images using a dictionary-based decompression algorithm, each data sequence being decompressed either in a first mode in which the decompressed image has added to the image a copy of the sequence, or in a second mode including adding a data sequence of the previously read image added to the decompressed image, or in a third mode including adding a data sequence of a previously decompressed image. The method also includes projecting a light beam based on each decompressed image.

### TECHNICAL FIELD

The invention relates to the field of motor-vehicle lighting and the projection of dynamic light beams using a lighting device of a motor vehicle. More specifically, the invention relates to a method for projecting a dynamic lighting beam using a lighting system of a motor vehicle.

### BACKGROUND OF THE INVENTION

Modern motor-vehicle lighting systems comprise an increasing number of light sources that have to be controlled in order to provide adaptive lighting functionalities.

Thanks to the miniaturization of electronic lighting components and to the wide variety of light emission colours and intensities able to be produced by such systems, it is nowadays possible to use vehicle lighting systems as headlights in order to project a succession of one or more images onto the road, which thus acts as a projection surface. Said succession of images may thus form an “adaptive lighting” function, a “driving assistance” function, a transitional function between two separate photometric functions, or else a “welcome or farewell scenario” function. The projected images may thus address for example security information communication, comfort or aesthetic needs, aimed in particular at the driver of the vehicle or at drivers of nearby vehicles.

Typically, lighting systems are controlled by a control unit called PCM (“pixel controller module”) able to command a lighting module of the lighting system. A sequence of digital images, stored beforehand in a memory of the vehicle, is provided to the control unit in order to be projected by the lighting module in the form of a dynamic light beam.

The CAN protocol is often used, in some of its variants (CAN-FD is one of the most commonly used) to transfer data between said memory and the control unit. However, some motor vehicle manufacturers decide to limit the bandwidth of the CAN protocol, thereby impacting management operations, which generally require around 5 Mbps. It is therefore common to store videos and digital images in the form of compressed video and images in order to comply with these limitations. The control unit of the vehicle is then responsible for decompressing these images in order then to be able to control the lighting module.

However, in this type of lighting system, the speed of projection along with the cost of the components of said system are two key parameters of said system. Indeed, in order to maximize the projection speed of a dynamic light beam, it is necessary for the compressed images to be decompressed as quickly as possible.

There is thus a need for a method for projecting a dynamic light beam based on a sequence of compressed images that is more reactive than the methods known at present.

### SUMMARY OF THE INVENTION

The present invention falls within this context and aims to address this need.

For these purposes, one subject of the invention is a method for projecting a dynamic lighting beam using a lighting system of a motor vehicle, the lighting system comprising a memory storing a compressed video comprising a plurality of successive images each consisting of a plurality of data sequences, a control unit and a lighting module, characterized in that it comprises the following steps:
a. reading each image from the compressed video stored in the memory;
b. for each read image, the control unit decompressing said image using a dictionary-based decompression algorithm to give a decompressed image, each data sequence of the read image being decompressed either in a first mode in which the decompressed image has added to it a copy of said sequence, or in a second mode in which the decompressed image has added to it a data sequence of said previously read image added to the decompressed image, or in a third mode in which the decompressed image has added to it a data sequence of a previously decompressed image;
c. the lighting module projecting a pixelated light beam, determined based on each decompressed image.

The invention proposes to use dictionary-based compression families, such as in particular LZx compressions, also called Lempel-Ziv compressions. It will thus be understood that, thanks to the invention, each image is decompressed based on compressed sequences from a dictionary formed from the compressed image currently being read and from a previous compressed image. The previously added image may be the last image decompressed before the read image, or another image previously decompressed before the read image.

As is known, one of the major drawbacks of dictionary-based compression algorithms lies in the fact that these achieve only poor compression rates if the proportion of similar data within the image to be compressed is low. The invention is noteworthy in that it uses the fact that two consecutive images of a video are highly similar to increase the compression rate of the video, and thereby increase the decompression speed of the corresponding compressed video. Indeed, the image resulting from the difference between any two consecutive images of the video will comprise a significant number of similar data, in particular null data. It will then be understood that, by doing this, the compressed video will comprise significantly fewer data in comparison with a compression performed directly on each image of the video; thus improving the decompression speed.

In the context of the invention, that is to say the projection of dynamic light beams using a lighting device of a motor vehicle, the main limiting factor is the decompression speed of the video that it is desired to project. Indeed, excessively slow decompression of the compressed video will have a negative impact on the visual quality of the projected light beam; in addition, it will be understood that, given the problem that the invention solves, the compression time of a video does not constitute a limiting factor.

In the present invention, a “data sequence” is understood to mean a finite and ordered set of units of information, in particular bits of information, or bytes, or even hexadecimal data.

In the present invention, a “dynamic lighting beam” is understood to mean a light beam whose photometric characteristics, in particular the distribution of its illuminance, change in a predetermined manner over time. For example, such a dynamic lighting beam may represent a visual animation, such as the changing of a logo, of an image or of a pattern. Said visual animation may in particular comprise a succession of at least 100 images, following one another with a frequency of at least 20 Hz. Still by way of example, the dynamic lighting beam may be projected onto the road or displayed on a screen.

In the present invention, a “control unit” is understood to mean a computing module able to manipulate digital data, in particular a processor of a computer, and able to communicate with memory storage devices and/or electronic devices, in particular via cables or a wireless link, such as headlights of a motor vehicle.

In the present invention, a “data sequence comparison” is understood to mean the determination of a degree of similarity between two data sequences, said degree of similarity may in particular be a numerical value determined using a mathematical method relating to the units of information of said sequences. In the present invention, a “similarity function” is understood to mean such a mathematical method implementing a data sequence comparison, said procedure receiving two data sequences of the same length at input and returning a numerical value corresponding to the degree of similarity between said sequences.

The similarity function may in particular determine the degree of similarity between two data sequences by way of a strict comparison between pairs of units of information of these sequences, or else by way of a comparison of a norm between the pairs of units of information of these sequences with regard to a given maximum difference, the difference being able to be identical for each of the pairs of data or specific to each pair of data. Where applicable, the similarity function may take into account the length of the data sequences.

Advantageously, the degree of similarity d_{S} between a sequence σ and a reference sequence S, of the same length as the sequence σ, may be calculated using the following formula:

$${d}_{S} ( σ ) = w ℒ ( σ ) + {\sum }_{i = 1}^{ℒ ( σ )} ( 1 - \frac{\vert {S}_{i} - {σ}_{i} \vert}{{ε}_{max}} ) , \qquad [ Math . 1 ]$$

where the term [symbol] (σ) corresponds to the length of the sequence σ; σᵢ corresponds to the i-th element of the sequence σ; the coefficient w is a penalty parameter on the length of the sequences; and εₘₐₓ is a given maximum difference. It will then be understood that, given two data sequences of the same length s1 and s2, the similarity function associated with the degree of similarity from equation [Math. 1] is given by:

$$φ ( s 1 , s 1 ) = {d}_{s 1} ( s 2 ) . \qquad [ Math . 2 ]$$

In the present invention, two compared data sequences will be considered to be “similar” when their degree of similarity, determined by a given similarity function, is greater than a predetermined tolerance threshold, this threshold thus being a numerical value representing a margin according to which it is possible to consider two separate sequences to be similar or not similar.

In the invention, the reading, decompression and projection steps may be implemented sequentially, that is to say image by image. As a variant, multiple images may be read successively and stored in a buffer memory, the decompression and projection steps then being implemented on the images stored in the buffer memory. As another variant, the reading and decompression steps may be implemented sequentially, that is to say image by image, the decompressed images then being stored in a buffer memory, and the projection step then being implemented on the decompressed images stored in the buffer memory.

In the invention, a “lighting module” is understood to mean a module able to emit a pixelated light beam, in particular arranged in a front headlight of a motor vehicle, and arranged such that the pixelated light beam is a light beam comprising a plurality of pixels, for example at least 2500 pixels of dimensions between 0.05° and 0.3°, distributed in a plurality of rows and columns, for example 50 rows and 50 columns. As a variant, the lighting module may be a screen, in particular arranged in a front headlight or a rear light of a vehicle, and able to display images of at least 2500 pixels of dimensions between 0.05° and 0.3°, distributed in a plurality of rows and columns, for example 50 rows and 50 columns.

For example, the lighting module may comprise a plurality of elementary light sources. Where applicable, a controller may be arranged to selectively control each of the elementary light sources of the lighting module so that this light source emits an elementary light beam forming one of the pixels of the pixelated light beam or of the image.

A “light source” is understood to mean any light source possibly associated with an electro-optical element, capable of being selectively activated and controlled so as to emit an elementary light beam the light intensity of which is controllable. This may in particular be a light-emitting semiconductor chip, a light-emitting element of a monolithic pixelated light-emitting diode, a portion of a light-converting element able to be excited by a light source or else a light source associated with a liquid crystal or with a micromirror.

In the invention, each data sequence of the read image comprises a header containing a decompression code and, in the decompression step, each data sequence of the read image is decompressed in the first, the second or the third mode depending on the decompression code contained in the header of said sequence.

Thanks to the decompression code, each data sequence of the read image is decompressed separately depending on whether said compressed data sequence needs to be copied literally to the decompression stack; or depending on whether the data sequence to be copied to the decompression stack corresponds to a data sequence of the image currently being decompressed and preceding said data sequence currently being decompressed; or depending on whether the data sequence to be copied to the decompression stack corresponds to a data sequence of a previously decompressed image, and in particular the image preceding the image currently being decompressed.

In the first mode, the copy of the sequence may be a partial copy, and in particular a copy of the sequence except for a header of this sequence.

Advantageously, when the header of the data sequence of the read image comprises a decompression code indicating the first mode, said sequence comprises a code for a number N1 and, in the decompression step, said data sequence of the read image is decompressed in the first mode by adding, to the decompressed image, the N1 data blocks following said code for the number N1.

Thanks to the code for the number N1, it is possible to decompress a precise amount of information on the decompression stack of the image at the same time as the amount of data needed to reconstruct the decompressed image is minimized. Advantageously, the header may consist of a data sequence, in particular bits, consisting of two complementary sub-sequences, each respectively coding for the decompression code and for the code for the number N1.

Advantageously, the decompression code may consist of a sequence of 4 bits, in particular all having the value zero.

In one alternative or additional embodiment of the invention, when the header of the data sequence of the read image comprises a decompression code indicating the second or the third mode, said sequence comprises an original position code O and a code for a length L. Advantageously, in the decompression step, said data sequence of the read image is decompressed in the second or the third mode by adding, to the decompressed image, the L data added to the decompressed image or to a previously decompressed image from the original position or up to the original position.

Thanks to the original position and length codes, it is possible to indicate the exact address of a data sequence, in particular the start position indicates the start of the sequence to be copied sequentially until the number of copied data corresponds to the length indicated by the length code L.

The decompression code may for example correspond to four data, in particular four bits with a value of zero.

If desired, when the header of the data sequence of the read image comprises a decompression code indicating the second or the third mode, the header and the code for the original position of said sequence together form a predetermined number N2 of data blocks. Advantageously, in the decompression step, the original position is obtained from all of the remaining data of the N2 data blocks from the header, which form the code for the original position O.

Thanks to this configuration, the encoding of the header ensures the continuity of the data sequences and minimization of the memory space that is taken up.

In one alternative or additional embodiment of the invention, when the header of the data sequence of the read image comprises a decompression code indicating the second or the third mode, said length L is obtained from the value of the decompression code, which forms or forms part of the code for the length L.

Thanks to this configuration, the encoding of the header ensures the continuity of the data sequences and minimization of the memory space that is taken up.

Advantageously, when the header of the data sequence of the read image comprises a decompression code indicating the second or the third mode, in the decompression step, said length L is obtained by adding the value of the decompression code and of each of the data blocks following the code for the original position O until one of these blocks contains a datum equal to a predetermined value, the set of said blocks forming the code for the length L.

Thanks to this iterative procedure, it is possible to encode any length in a data sequence in which the elements forming said sequence, for example bytes, are each able to contain only a limited amount of information; it will then be understood that the invention takes advantage of encoding that makes it possible to overcome the information storage capacity constraint of said elements.

In one alternative or additional embodiment of the invention, when the header of the data sequence of the read image comprises a decompression code indicating the second or the third mode, said header comprises a literal copy code indicating the presence or the absence of a last block in said sequence and, in the decompression step, if said literal copy code indicates the presence of a last block in said sequence, said last block of said sequence is added to the decompressed image at the end of said L added data.

Thanks to this configuration, the encoding of the header ensures correct decompression of the information contained in all of the compressed data blocks while at the same time ensuring the continuity of the data sequences. Advantageously, the data blocks may correspond to bytes of information.

In one embodiment of the invention, when the header of the data sequence of the read image comprises a decompression code indicating the second or the third mode, said header comprises a target code indicating the second or the third mode. Advantageously, in the decompression step, said data sequence of the read image is decompressed in the second mode, if the target code has a first value, by adding, to the decompressed image, the L data added to the decompressed image from the original position or in the third mode; if the target code has a second value, by adding, to the decompressed image, the L data added to a previously decompressed image from the original position or up to the original position.

Thanks to this configuration, the encoding of the header ensures correct decompression of the information contained in all of the compressed data blocks while at the same time preserving the continuity of the data sequences. Advantageously, the data blocks may correspond to bytes of information.

According to one exemplary embodiment of the invention, when the header of the data sequence of the read image comprises a target code indicating the third mode, said header comprises a reading direction code indicating a reading direction of the data to be added to the decompressed image and, in the decompression step, said data sequence of the read image is decompressed in the third mode by adding, to the decompressed image, the L data added to a previously decompressed image from the original position if the reading direction code has a first value or up to the original position if the reading direction code has another value.

Thanks to this feature, it is possible to distinguish, by way of the reading direction code, the copying direction in which the decompressed data should be added to the decompression stack.

Advantageously, for each decompressed image, the pixelated light beam is determined based on the sum of this decompressed image and all of the previously decompressed images.

Thanks to this feature, it is then possible to fully reconstruct the video as an additive superposition of the succession of decompressed images, and in addition, the digital decoding of the images allows the lighting module to project said video onto any surface, in particular the ground.

Advantageously, each decompressed image may be formed of a greyscale pixel matrix. Where applicable, the lighting system may comprise a lighting module controller able to control each elementary light source of said lighting module and the projection step may comprise a step of the controller transforming the greyscale of each pixel of the decompressed image into an emission setpoint, in particular into a duty cycle, and a step of the controller controlling each elementary light source, the position of which corresponds to the position of a pixel of the decompressed image, so as to emit an elementary light beam in accordance with the emission setpoint established based on this corresponding pixel. In other words, the set of elementary beams will form a representation of the decompressed image. It is possible to contemplate the compressed video comprising three channels, red, green and blue, the reading, decompression and projection steps thus being implemented for each of the channels.

Another subject of the invention is a method for compressing an initial video, implemented by a computing system, characterized in that it comprises the following steps:
a. reading each image from the initial video,
b. compressing each read image to give a compressed image, said compression step comprising the following steps, for each read datum from the read image, called current datum:
c. reading a datum from the read image, called current datum;
d. selecting a first data sequence of the read image, from among a set of data sequences of the read image beginning with this current datum, and a second data sequence, from among a set of preceding data sequences of the read image and a set of data sequences of a preceding image that together maximize a data sequence similarity function;
e. depending on the length of said selected first data sequence, adding, to the compressed image, a third data sequence comprising the current datum or a compressed sequence determined based on the original position and on the length of the selected second data sequence;
f. each read datum from the read image being the first datum of the read image, and then each first datum of the read image situated after the last datum of said selected first data sequence;
g. storing each compressed image in a memory of the computing system so as to form a compressed video.

In other words, the invention proposes to compress a video by sequentially compressing each of the images of said video by way of a dictionary created on the fly based on a data sequence extracted from the image currently being compressed or from a preceding image, in particular the last read image. In addition, thanks to the maximum similarity character between the sequences used in the gradual creation of the compression dictionary, it is possible to improve the final compression rate of the initial video. As a variant, the method may use a buffer memory simultaneously storing multiple images that are read and then decompressed from said buffer memory and projected sequentially. As another variant, the method may perform sequential reading and decompression of the images of the compressed video, which are then stored in a buffer memory and then projected directly from the buffer memory.

Advantageously, for two data sequences, the similarity function of these data sequences is determined on the basis of the length of said data sequences; of the difference between two corresponding data of these data sequences; and of a predetermined tolerance threshold for said difference.

By doing this, the calculation of the degree of similarity between two data sequences, by way of the similarity function, takes into account quantitative characteristics of said sequences, in particular the length of said sequences and the numerical difference between the data forming said sequences and a reference threshold value. It will then be understood that the invention seeks to increase the overall compression rate of the initial video by maximizing the multi-criteria data sequence similarity function by allowing differences between two sequences, provided that said differences are smaller than the predetermined tolerance threshold.

In one alternative or additional embodiment of the invention, the set of preceding data sequences of the read image, in which the second data sequence is sought, consists of all of the data sequences of the read image beginning with a preceding datum of the image whose position is spaced from the position of the current datum by at most a first predetermined distance. Advantageously, the set of data sequences of a preceding image, in which the second data sequence is sought, consists of all of the data sequences of the preceding image beginning with a datum whose position is spaced from the position of the current datum by at most a second predetermined distance, in particular equal to half the first predetermined distance.

In other words, the search for the second data sequence is carried out by way of a sliding window, thereby making it possible to reduce the computational cost of the search for similar data sequences and therefore the compression time of the initial video.

In one alternative or additional embodiment of the invention, for each current datum, the third data sequence comprises a header, and said header comprises a decompression code indicating whether said third data sequence comprises the current datum or the compressed sequence.

In other words, the decompression code of the header specifies the type of compressed information found at the end of said code, thus making it possible to ascertain how the decompression should be continued.

Advantageously, if the decompression code indicates that the third data sequence comprises the compressed sequence, said third data sequence comprises a code for an original position of the selected second data sequence and a code for a length L of the selected second data sequence.

By doing this, the original position and the code for the length L make it possible to point precisely to a data sequence to be copied during the decompression of the compressed video in order to partially reconstruct same.

Advantageously, if the decompression code indicates the third mode, the structure of a data sequence of the image is organized sequentially as follows:
a. decompression code indicating the first or second/third mode, said decompression code may in particular be encoded in the form of four bits, all zero in the case of the first mode, and containing at least one non-zero bit in the case of the second or third mode;
b. literal copy code, coded in particular on one bit and indicating, depending on the value of said code, the presence or the absence of a last block of the data sequence to be added at the last position of the decompressed data sequence;
c. target code, coded in particular on one bit, indicating, depending on the value of said code, whether the sequence should be decompressed in the second or the third mode, corresponding to decompression based on the current image or a preceding image;
d. reading direction code, coded in particular on one bit, indicating, depending on the value of said code, the reading direction of the data to be added to the decompressed image;
e. original position code, coded in particular on 9 or 10 bits depending on whether the sequence needs to be decompressed in the second or the third mode, respectively, indicates the origin of the data to be copied during the decompression step.

Advantageously, if the decompression code indicates the second mode, the structure of a data sequence of the image is organized in the same way as in the case of the third mode, with the difference that the reading direction code is not necessary. Indeed, the second mode refers to data present in the image currently being decompressed, the reading direction cannot be two ways, and therefore the presence of said reading direction code is superfluous.

According to one alternative or additional exemplary embodiment of the invention, the compression step comprises, for each current datum, depending on the length of said selected first data sequence:
a. adding, to the compressed image, a third data sequence comprising the current datum or
b. adding, to the compressed image, a third data sequence comprising a compressed sequence determined based on the original position and on the length of the selected second data sequence or
c. adding the current datum to a third data sequence previously added to the compressed image.

By doing this, the compression method constructs a compressed video as a concatenation of compressed data sequences, such that each of said sequences is compressed in one, and only one, of the modes from among the three described modes.

### BRIEF DESCRIPTION OF DRAWINGS

The present invention is now described using examples that are only illustrative and in no way limit the scope of the invention, and with reference to the appended drawings, in which drawings the various figures show:

FIG. 1 schematically and partially shows a method for compressing a video according to one embodiment of the invention;

FIG. 2a and FIG. 2b schematically and partially show the search for the best data sequence similar to an initial data sequence from among the current data sequence and another data sequence;

FIG. 2c schematically and partially shows a compressed sequence obtained at the end of the examples of FIG. 2a and FIG. 2b;

FIG. 3 schematically and partially shows a method for projecting a compressed video according to one embodiment of the invention;

FIG. 4 schematically and partially shows a lighting system of a motor vehicle implementing the method for projecting a dynamic lighting beam of FIG. 3;

FIG. 5 schematically and partially shows a method for decompressing a video compressed using the compression method of the present invention;

FIG. 6a, FIG. 6b and FIG. 6c schematically and partially show the structure of three different data blocks compressed in each of the three described modes according to one embodiment of the invention.

### DETAILED DESCRIPTION OF THE INVENTION

In the following description, elements that are identical in structure or in function and appear in various figures keep the same reference sign, unless otherwise stated.

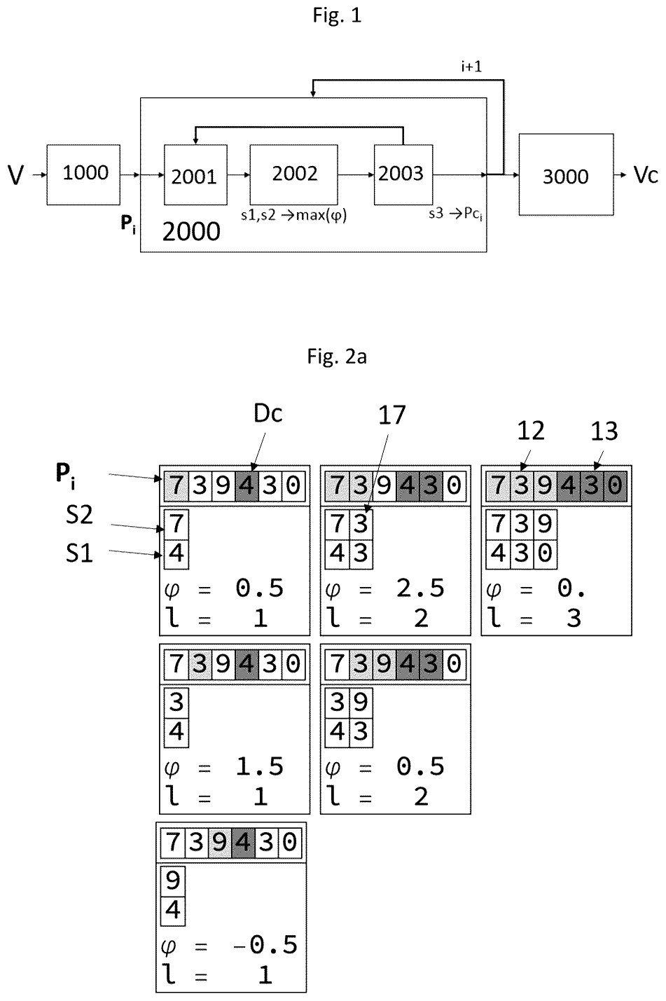

FIG. 1 shows a method for compressing an initial video V, for example showing a lighting scenario intended to be projected by a motor vehicle.

It is first proposed to disclose the operation of the compression method through the succession of steps forming it. The method for compressing an initial video V, implemented by a computing system, comprises the following steps:
a. step 1000 of reading each image Pi from the initial video V,
b. step 2000 of compressing each read image Pi to give a compressed image PCi, said compression step comprising the following sub-steps:
i. sub-step 2001 of reading a datum from the read image Pi, called current datum DC;
ii. sub-step 2002 of selecting a first data sequence S1 of the read image Pi, from among a set of data sequences of the read image Pi beginning with this current datum DC, and a second data sequence S2, from among a set of preceding data sequences of the read image Pi and a set of data sequences of a preceding image Pi-1 that together maximize a data sequence similarity function ¢;
iii. depending on the length of said selected first data sequence S1, sub-step 2003 of adding, to the compressed image PCi, a third data sequence S3 comprising the current datum DC or a compressed sequence determined based on the original position and on the length of the selected second data sequence S2;
iv. each read datum from the read image Pi being initially the first datum of the read image Pi, and then each first datum of the read image Pi situated after the first datum of said selected first data sequence S1, and steps 2001 to 2003 being repeated for each new read datum;
c. step 3000 of storing each compressed image PCi in a memory of the computing system so as to form a compressed video VC.

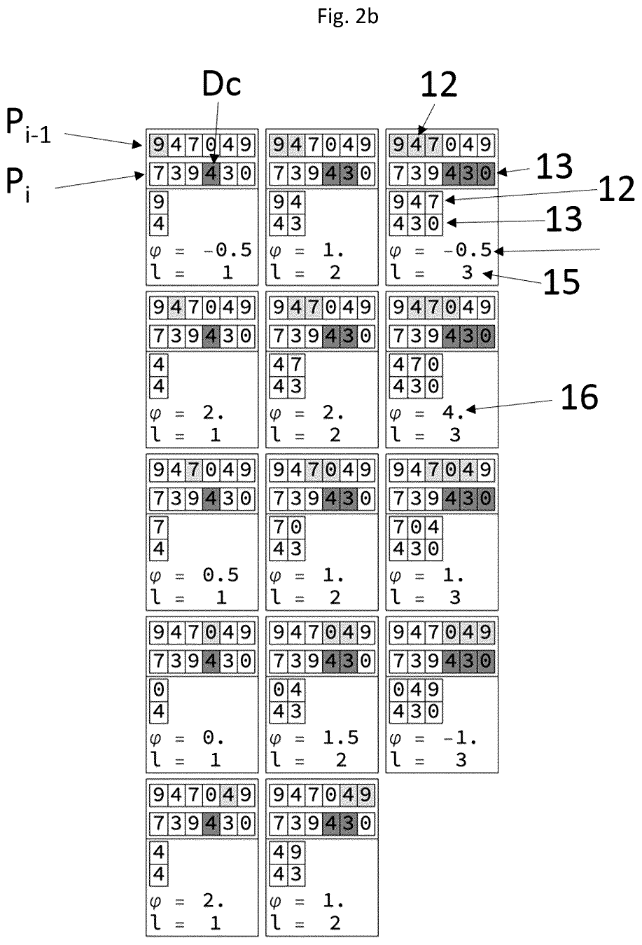

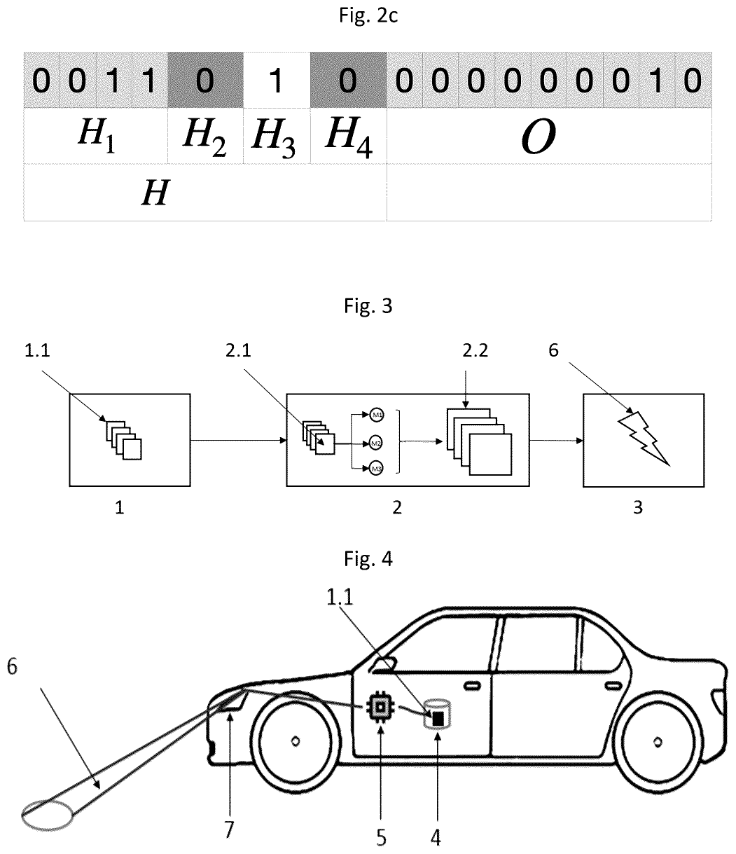

FIG. 2a and FIG. 2b show one example of the progress of the step 2002 of selecting a first data sequence S1 of a read image Pi, from among a set of data sequences of the read image Pi beginning with a current datum DC, and a second data sequence S2, from among a set of data sequences of a preceding image Pi-1, that together maximize a data sequence similarity function ¢.

As shown in FIG. 2a, the set of preceding data sequences of the read image Pi, in which the second data sequence S2 is sought, consists of all of the data sequences of the read image Pi beginning with a preceding datum of the read image Pi whose position is spaced from the position of the current datum DC by at most a first predetermined distance. In other words, the second sequence S2 is sought in the read image Pi from among all of the sequences contained within a sliding window of predetermined size and finishing on the current datum DC. This second sequence S2 is thus the longest sequence contained within the sliding window and that has the highest degree of similarity with the sequence S1.

In the example of FIG. 2a, which has been simplified, this longest data sequence S2 preceding the current datum DC is the sequence [7 3], whereas the first sequence S1 is the sequence [4 3]. It will be noted that these sequences are not identical, but are those that maximize a similarity function ϕ from among all of the data sequences contained within a sliding window of size 3. This thus introduces, in contrast to dictionary-based compression algorithms, a loss of information during the compression that makes it possible to improve the compression rate while still remaining acceptable.

As shown in FIG. 2b, the set of data sequences of a preceding image Pi-1, in which the second data sequence S2 is also sought, consists of all of the data sequences of the preceding image Pi-1 beginning with a datum whose position is spaced from the position of the current datum DC by at most a second predetermined distance, advantageously equal to half the first distance. In other words, the second sequence S2 is also sought in the preceding image Pi-1 from among all of the sequences contained within a sliding window of predetermined size and centred on the current datum DC. This second sequence S2 is thus the longest sequence contained within the sliding window and that has the highest degree of similarity with the sequence S1.

In the example of FIG. 2b, which has been simplified, this longest data sequence S2 preceding the current datum DC is the sequence [4 7 0], whereas the first sequence S1 is the sequence [4 3 0]. It will be noted that these sequences are not identical, but otherwise maximize a similarity function ϕ from among all of the data sequences contained within a sliding window of size 6.

It will be noted that the search for the second sequence S2 is carried out in each of the two sets so as to arrive at two intermediate data sequences, each maximizing the similarity function ϕ with respect to the set of sequences to which it belongs, and that the second sequence S2 is the sequence from among these two intermediate sequences that maximizes said function ϕ.

In the example of FIG. 2a and FIG. 2b, it is therefore the sequence [4 7 0] that is therefore selected for the compression.

When executing this step, the calculation of the similarity function ϕ for each element of the set of data sequences of the read image Pi beginning with said current datum DC and the set of data sequences of a preceding image Pi-1 takes into account the length 1 of the data sequences. In particular, it is possible to use a similarity function based on the estimation of a degree of similarity as presented in equation [Math. 1].

In the example of FIG. 2a and FIG. 2b, the length 1 of the selected first sequence S1 is greater than 1. At the end of step 2003, the third sequence S3 that will be added to the compressed image PCi will thus comprise the original position and the length of the selected second data sequence S2 in the preceding image PCi-1. FIG. 2c shows one example of such a third sequence S3.

This third sequence S3 comprises a header H, comprising:
a. a decompression code H1, in the form of four bits, indicating both that the sequence S1 has been compressed with reference to the second sequence S2 and the length of this sequence S2;
b. a literal copy code H2, coded on one bit, and indicating that the last block of the data sequence S3 should not be copied literally during the decompression;
c. a target code H3, coded on one bit, indicating that the sequence S2 forms part of the preceding image PCi-1;
d. a reading direction code H4, coded on one bit, indicating that the sequence S2 is contained in the preceding image PCi-1 to the left of the position of the current datum DC;

This third sequence S3 also comprises, following the header H, a block containing an original position code O, coded on 9 bits, indicating the offset of the original position of the second sequence S2 with respect to the position of the current datum DC. It will be noted that, if the length of the second sequence S2 cannot be coded on four bits, this length will also be coded in other blocks of the sequence S3 following the block containing the code O.

It will be noted that, if the sequence S2 forms part of the read image and not of the preceding image, the reading direction code H4 is not necessary, since the sequence S2 is necessarily located to the left of the current datum DC. In this case, the original position code O may be coded on 10 bits.

Finally, if the length 1 of the selected first sequence S1 is equal to 1, the third sequence S3 that will be added to the compressed image PCi will contain the current datum along with a header indicating firstly that this sequence S3 contains a datum to be copied literally during the decompression and secondly the number of blocks following the header that contain these data to be copied.

Still in the case of a length equal to 1, it should also be noted that it is possible, when the preceding third data sequence has been compressed, for the preceding current datum, referring to a data sequence of the current image or of the preceding image, to add a data block containing literally the present current datum to the end of this preceding third data sequence. In this case, the literal copy code H2 will indicate that the last block of the data sequence S3 should be copied literally during the decompression.

FIG. 3 shows a method for projecting a dynamic lighting beam using a lighting system 3 of a motor vehicle.

FIG. 4 shows this lighting system 3 of a motor vehicle, the lighting system comprising a memory 4 storing a compressed video 1.1 comprising a plurality of successive compressed images 2.1 each consisting of a plurality of data sequences, a control unit 5 and a lighting module 7 and implementing the projection method described above.

The compressed video 1.1 may for example have been compressed by way of the method described in FIG. 1 to FIG. 2c.

The method of FIG. 3 comprises the following steps:
a. step 1 of reading each compressed image 2.1 from the compressed video 1.1 stored in the memory 4;
b. for each read image, step 2 of the control unit 5 decompressing said image using a dictionary-based decompression algorithm to give a decompressed image 2.2,
c. step 3 of the lighting module 7 projecting a pixelated light beam 6, determined based on each decompressed image 2.2.

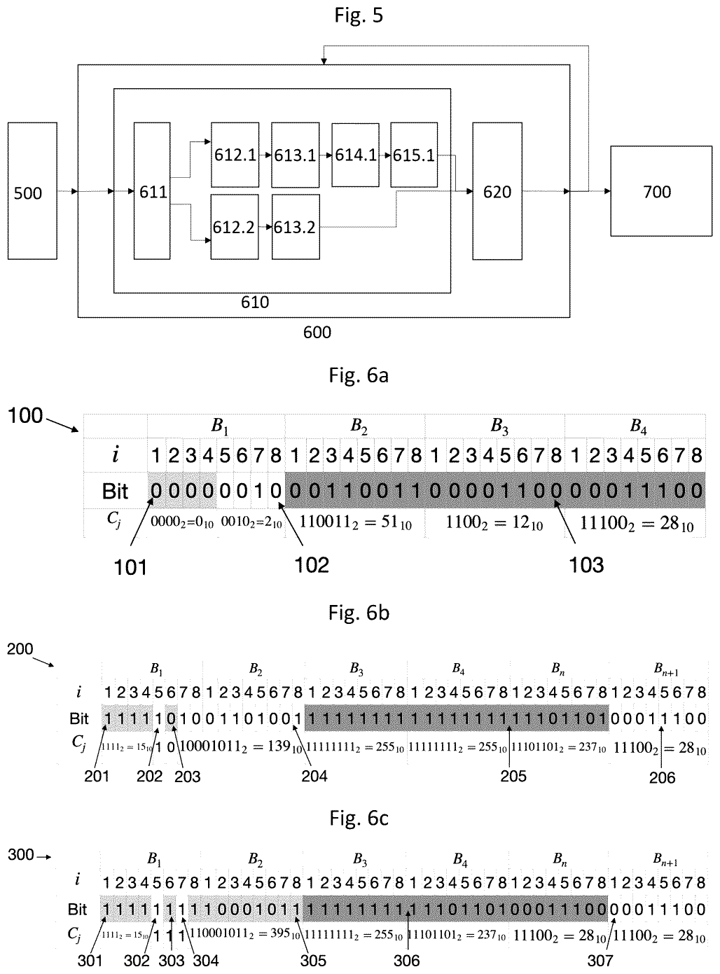

As shown in FIG. 5, each read compressed datum from each compressed image of the compressed video is decompressed in one of the three possible modes depending on whether this datum was compressed while literally including the original datum, with reference to a sequence of the current image, or with reference to a sequence of a preceding image, as was explained above.

FIG. 5 shows a decompression method able to be used in step 2 of the method of FIG. 3 and making it possible to decompress a video V that was compressed using the compression method described above. This decompression method comprises the following steps:
a. step 500 of reading each compressed image from the compressed video,
b. step 600 of decompressing the image currently being read according to the following sub-steps: for each data sequence conforming the compressed image currently being read,
i. sub-step 611 of reading the decompression code 101, 201, 301;
ii. if the decompression code 201, 301 is equal to a value indicating the second or third mode, the header comprises a literal copy code 202, 302 indicating the presence or the absence of a first block, sub-step 612.1 of reading said literal copy code;
iii. if the decompression code 101, 201, 301 is equal to a value, in particular zero, indicating the first mode, the data sequence comprises a code for a number N1 coded on 4 bits, sub-step 612.2 of reading said code for a number N1;
iv. if the decompression code 201, 301 indicates the second or third mode, the header comprises a target code 203, 303 indicating the second or third mode, sub-step 613.1 of reading said target code 203, 303;
v. if the decompression code 101, 201, 301 indicates the first mode, sub-step 613.2 of decompressing said data sequence by copying the N1 blocks following said code for a number N1 in the decompressed image;
vi. if the target code 303 indicates the third mode, sub-step 614.1 of reading a reading direction code 304;
vii. if the decompression code 201, 301 is equal to a value indicating the second or third mode, sub-step 615.1 of calculating a length L obtained from the sum of the decompression code 201, 301 and each of the data 205, 306 following the code for the original position until one of these blocks contains a datum equal to a predetermined value, in particular zero;
viii. sub-step 620 of decompressing the current data sequence in the modes specified by the set of codes used for the decompression;
c. step 700 of creating a decompressed video as an assembly of a succession of decompressed images each obtained as a sum, pixel by pixel, of the last decompressed image and all of the previously decompressed images.

FIG. 6a shows one example of a data sequence of a read image 100 comprising a decompression code 101 indicating the first mode and a code 102 for a number N1, the two codes then forming a header of said data sequence, corresponding in particular to the first byte of the data sequence.

The decompression code 101 is encoded by way of 4 bits, in particular 4 zero bits, indicating the number 0 in decimal base.

The code for a number N1 is encoded by way of 4 bits following the 4 bits encoding the decompression code 101; in the example, said code for a number N1 corresponds to the number 0010 in binary base, this corresponding to the number 2 in decimal base. The encoded number N1 is thus equal to 3, obtained by adding one unit to the decimal base number of the binary code formed by the four bits identified previously. The number N1 corresponds to the number of blocks, in particular bytes, following said code for the number N1 that are to be copied in the step of decompressing the read data sequence.

FIG. 6b shows one example of a data sequence of a read image 200 comprising a decompression code 201 indicating the second or third mode; a literal copy code 202, a target code 203 and an original position code 204.

Thus, when the header of the data sequence of the read image comprises a decompression code 201 indicating the second or the third mode, said sequence comprises an original position code 204 and a code for a length L 201, 205, such that, in the decompression step, said data sequence of the read image is decompressed in the second or the third mode by adding, to the image decompressed in the second or the third mode, by adding, to the decompressed image, the L data added to the decompressed image or to a previously decompressed image from the original position or up to the original position.

In addition, when the header of the data sequence of the read image comprises a decompression code 201, 301 indicating the second or the third mode, in the decompression step, said length L is obtained by adding the value of the decompression code 201, fifteen in the example, and of each of the data blocks 205 following the code for the original position 204 until one of these blocks contains a datum equal to a predetermined value, the set of said blocks forming the code for the length L 201, 205.

Thus, when the header of the data sequence of the read image comprises a decompression code 201, 301 indicating the second or the third mode, said header comprises a literal copy code 202, 302 indicating the presence or the absence of a last block 206, 307 in said sequence, such that, in the decompression step, if said literal copy code 202, 302 indicates the presence of a last block 206, 307 in said sequence, said last block of said sequence 206, 307 is added to the decompressed image at the end of said L added data, in the example: two hundred and fifty five, two hundred and fifty five and two hundred and thirty seven; that is to say a total of seven hundred and sixty two.

Thus, when the header of the data sequence of the read image comprises a decompression code 201, 301 indicating the second or the third mode, said header comprises a target code 203, 303 indicating the second or the third mode. Advantageously, in the decompression step, said data sequence of the read image is decompressed in the second mode, if the target code 203 has a first value, in particular a zero bit 200 in the example, by adding, to the decompressed image, the

L data added to the decompressed image from the original position or in the third mode, if the target code 203 has a second value, in particular a bit equal to one, by adding, to the decompressed image, the L data added to a previously decompressed image from the original position or up to the original position.

When the header of the data sequence of the read image comprises a decompression code 201, 301 indicating the second or the third mode, said header comprises a literal copy code 202, 302 indicating the presence or the absence of a last block 206, 307 in said sequence.

In the decompression step, if said literal copy code 202, 302 indicates the presence of a last block in said sequence, said last block 206, 307 of said sequence is added to the decompressed image after said L added data.

FIG. 6c shows one example of a data sequence of a read image 300 comprising a decompression code 301 indicating the second or third mode; a literal copy code 302, a target code 303; a reading direction code 304 and an original position code 305.

Thus, when the header of the data sequence of the read image comprises a decompression code 301 indicating the second or the third mode, said sequence comprises an original position code 305 and a code for a length L 301, 306, such that, in the decompression step, said data sequence of the read image is decompressed in the second or the third mode by adding, to the image decompressed in the second or the third mode, by adding, to the decompressed image, the L data added to the decompressed image or to a previously decompressed image from the original position or up to the original position.

In addition, when the header of the data sequence of the read image comprises a decompression code indicating the second or the third mode, in the decompression step, said length L is obtained by adding the value of the decompression code 301, fifteen in the example, and of each of the data blocks 305 following the code for the original position 305 until one of these blocks contains a datum equal to a predetermined value, in particular zero, the set of said blocks forming the code for the length L 301, 306.

Thus, when the header of the data sequence of the read image comprises a decompression code 301 indicating the second or the third mode, said header comprises a literal copy code 302 indicating the presence or the absence of a last block 307 in said sequence, such that, in the decompression step, if said literal copy code 302 indicates the presence of a last block 307 in said sequence, said last block of said sequence 307 is added to the decompressed image at the end of said L added data, in the example: two hundred and fifty five, two hundred and fifty five and two hundred and thirty seven; that is to say a total of seven hundred and sixty two.

Thus, when the header of the data sequence of the read image comprises a decompression code 301 indicating the second or the third mode, said header comprises a target code 303 indicating the second or the third mode. Advantageously, in the decompression step, said data sequence of the read image is decompressed in the second mode, if the target code 303 has a first value, in particular a zero bit, by adding, to the decompressed image, the L data added to the decompressed image from the original position or in the third mode, if the target code 303 has a second value, in particular a bit equal to one as in the example, by adding, to the decompressed image, the L data added to a previously decompressed image from the original position or up to the original position.

When the header of the data sequence of the read image comprises a decompression code 301 indicating the second or the third mode, said header comprises a literal copy code 302 indicating the presence or the absence of a last block 307 in said sequence and, in the decompression step, if said literal copy code 302 indicates the presence of a last block in said sequence, said last block 307 of said sequence is added to the decompressed image at the end of said L added data.

When the header of the data sequence of the read image comprises a target code 303 indicating the third mode, said header comprises a reading direction code 304 indicating a reading direction of the data to be added to the decompressed image and, in the decompression step, said data sequence of the read image is decompressed in the third mode by adding, to the decompressed image, the L data added to a previously decompressed image from the original position if the reading direction code 304 has a first value, in particular a zero bit, or up to the original position if the reading direction code has another value, in particular a bit equal to one.

With reference again to FIG. 3, each decompressed image obtained at the end of the method of FIG. 5, forms a greyscale pixel matrix. Each pixel of this image may thus be transformed, depending on its greyscale, into an emission setpoint, for example in the form of a duty cycle. This emission setpoint may thus make it possible to control an elementary light source of the lighting module 7 whose position corresponds to the position of the corresponding pixel in the decompressed image. This elementary light source thus emits an elementary light beam in accordance with this emission setpoint. And the set of elementary beams then forms a representation of the decompressed image.

In any case, the invention should not be regarded as being limited to the embodiments specifically described in this document, and extends in particular to any equivalent means and to any technically feasible combination of these means.

What is claimed is:

1. A method for projecting a dynamic lighting beam using a lighting system of a motor vehicle, the lighting system including a memory storing a compressed video including a plurality of successive images each consisting of a plurality of data sequences, a control unit and a lighting module, the method comprising:
a. reading each image from the compressed video stored in the memory;
b. decompressing a decompressed image, for each image read with the control unit, using a dictionary-based decompression algorithm to give a decompressed image, each data sequence of the read image being decompressed either in a first mode in which the decompressed image has added to the decompressed image a copy of the sequence, or in a second mode in which the decompressed image has added to the decompressed image a data sequence of the previously read image added to the decompressed image, or in a third mode in which the decompressed image has added to the decompressed image a data sequence of a previously decompressed image;
c. projecting, by the lighting module, a pixelated light beam, determined based on each decompressed image.

2. The method for projecting a dynamic lighting beam using a lighting system of a motor vehicle according to claim 1, wherein each data sequence of the read image includes a header containing a decompression code and decompressing a decompressed image includes each data sequence of the read image being decompressed in the first, the second or the third mode depending on the decompression code contained in the header of the sequence.

3. The method for projecting a dynamic lighting beam using a lighting system of a motor vehicle according to claim 2, wherein, when the header of the data sequence of the read image includes a decompression code indicating the first mode, the sequence includes a code for a number N1 and decompressing a decompressed image includes the data sequence of the read image being decompressed in the first mode by adding, to the decompressed image, the N1 data blocks following the code for the number N1.

4. The method for projecting a dynamic lighting beam using a lighting system of a motor vehicle according to claim 2, wherein, when the header of the data sequence of the read image includes a decompression code indicating the second or the third mode, the sequence includes an original position code and a code for a length L and decompressing a decompressed image includes the data sequence of the read image being decompressed in the second or the third mode by adding, to the decompressed image, the L data added to the decompressed image or to a previously decompressed image from the original position or up to the original position.

5. The method for projecting a dynamic lighting beam using a lighting system of a motor vehicle according to claim 4, wherein, when the header of the data sequence of the read image includes a decompression code indicating the second or the third mode, the header and the code for the original position of the sequence together form a predetermined number N2 of data blocks, and decompressing a decompressed image includes the original position being obtained from all of the remaining data of the N2 data blocks from the header, which form the code for the original position.

6. The method for projecting a dynamic lighting beam using a lighting system of a motor vehicle according to claim 4, wherein, when the header of the data sequence of the read image includes a decompression code indicating the second or the third mode, decompressing a decompressed image includes the length L being obtained from the value of the decompression code, which forms or forms part of the code for the length L.

7. The method for projecting a dynamic lighting beam using a lighting system of a motor vehicle according to claim 6, wherein, when the header of the data sequence of the read image includes a decompression code indicating the second or the third mode, decompressing a decompressed image includes the length L being obtained by adding the value of the decompression code and of each of the data blocks following the code for the original position until one of these blocks contains a datum equal to a predetermined value, the set of the blocks forming the code for the length L.

8. The method for projecting a dynamic lighting beam using a lighting system of a motor vehicle according to claim 4, wherein, when the header of the data sequence of the read image includes a decompression code indicating the second or the third mode, the header includes a literal copy code indicating the presence or the absence of a last block in the sequence and decompressing a decompressed image includes if the literal copy code indicates the presence of a last block in the sequence, the last block of the sequence is added to the decompressed image at the end of the L added data.

9. The method for projecting a dynamic lighting beam using a lighting system of a motor vehicle according to claim 4, wherein, when the header of the data sequence of the read image includes a decompression code indicating the second or the third mode, the header includes a target code indicating the second or the third mode and decompressing a decompressed image includes the data sequence of the read image being decompressed in the second mode, if the target code has a first value, by adding, to the decompressed image, the L data added to the decompressed image from the original position or in the third mode, if the target code has a second value, by adding, to the decompressed image, the L data added to a previously decompressed image from the original position or up to the original position.

10. The method for projecting a dynamic lighting beam using a lighting system of a motor vehicle according to claim 9, wherein, when the header of the data sequence of the read image includes a target code indicating the third mode, the header includes a reading direction code indicating a reading direction of the data to be added to the decompressed image and decompressing a decompressed image includes the data sequence of the read image being decompressed in the third mode by adding, to the decompressed image, the L data added to a previously decompressed image from the original position if the reading direction code has a first value or up to the original position if the reading direction code has another value.

11. The method for projecting a dynamic lighting beam using a lighting system of a motor vehicle according to claim 10, wherein, for each decompressed image, the pixelated light beam is determined based on the sum of this decompressed image and all of the previously decompressed images.

12. A method for compressing an initial video, implemented by a computing system, the method comprising:
a. reading each image from the initial video;
b. compressing each read image to give a compressed image, the compressing each read image includes, for each read datum from the read image, called current datum:
i. reading a datum from the read image, called current datum;
ii. selecting a first data sequence of the read image, from among a set of data sequences of the read image beginning with this current datum, and a second data sequence, from among a set of preceding data sequences of the read image and a set of data sequences of a preceding image that together maximize a data sequence similarity function;
iii. adding, to the compressed image depending on the length of the selected first data sequences, a third data sequence including the current datum or a compressed sequence determined based on the original position and on the length of the selected second data sequence;
each read datum from the read image being the first datum of the read image, and then each first datum of the read image situated after the last datum of the selected first data sequence;
c. storing each compressed image in a memory of the computing system so as to form a compressed video.

13. The method for compressing an initial video, implemented by a computing system, according to claim 12, wherein, for two data sequences, the similarity function of these data sequences is determined on the basis of the length of the data sequences; of the difference between two corresponding data of these data sequences, and of a predetermined tolerance threshold for the difference.

14. The method for compressing an initial video, implemented by a computing system, according to claim 12, wherein the set of preceding data sequences of the read image, in which the second data sequence is sought, consists of all of the data sequences of the read image beginning with a preceding datum of the image whose position is spaced from the position of the current datum by at most a first predetermined distance, and in that the set of data sequences of a preceding image, in which the second data sequence is sought, consists of all of the data sequences of the preceding image beginning with a datum whose position is spaced from the position of the current datum by at most a second predetermined distance.

15. The method for compressing an initial video, implemented by a computing system, according to claim 12, wherein for each current datum, the third data sequence includes a header, and the header includes a decompression code indicating whether the third data sequence includes the current datum or the compressed sequence.

16. The method for compressing an initial video, implemented by a computing system, according to claim 15, wherein, if the decompression code indicates that the third data sequence includes the compressed sequence, the third data sequence includes a code for an original position of the selected second data sequence and a code for a length L of the selected second data sequence.

17. The method for compressing an initial video, implemented by a computing system, according to claim 15, wherein compressing each read image includes, for each current datum, depending on the length of the selected first data sequence:
a. adding, to the compressed image, a third data sequence including the current datum or
b. adding, to the compressed image, a third data sequence including a compressed sequence determined based on the original position and on the length of the selected second data sequence or
c. adding the current datum to a third data sequence previously added to the compressed image.
